(19) United States
(12) Patent Application Publication
(10) Pub. No.: US 2004/0256401 A1
(43) Pub. Date: Dec. 23, 2004

(54) Beverage container attachment

(76) Inventor: David Jeffrey Chodosh, Manhattan Beach, CA (US)

Correspondence Address: CHRISTIE, PARKER & HALE, LLP, PO BOX 7068, PASADENA, CA, 91109-7068, US

(21) Appl. No.: 10/733,822

(22) Filed: Dec. 10, 2003

Related U.S. Application Data
(60) Provisional application No. 60/480,580, filed on Jun. 19, 2003.

(51) Int. Cl. A23L 1/00

(52) U.S. Cl. 220/912; 99/275

(57) ABSTRACT

A beverage container attachment is provided that includes a cup portion having an inner surface that forms a reservoir for receiving a food substance and a connector having an opening, wherein the connector is for attaching the cup portion to a beverage container. The beverage container attachment also includes a beverage regulator attached to a wall that defines the connector opening to allow a beverage to enter the reservoir through the connector opening while preventing the beverage from exiting through the connector opening.

### CROSS-REFERENCE TO RELATED APPLICATION

This application claims priority under 35 U.S.C. § 119(e) to U.S. Provisional Application Ser. No. 60/480,580, filed on Jun. 19, 2003, which is incorporated herein by reference.

### FIELD OF THE INVENTION

The present invention relates generally to a beverage container attachment and specifically to a beverage container attachment that includes a cup portion that forms a reservoir for receiving a food substance and having an opening with a structure attached thereto that allows fluid to enter through the opening, while preventing fluid from exiting through the opening.

### BACKGROUND OF THE INVENTION

Beverage cups and cup lids of varying types are commonly known. Open ended plastic cups are typically used to contain fountain drinks due to their insulating and waterproofing features. Re-sealable plastic beverage bottles, such as bottles having an open end with external threads that removably engage an internally threaded cap to form an enclosure for storing a beverage, are typically used to prepackage and store beverages. Re-sealable plastic beverage bottles are commonly used to prepackage beverages in part because they are portable, easy to refrigerate, resilient (i.e. unlikely to fracture if dropped or otherwise compressed), inexpensive to produce, and when sealed they keep the beverage pressurized and fresh (i.e., carbonated in cases where the beverage is a carbonated beverage.)

A popular drink recipe that has been known for many years is a “beverage float,” which is made by combining a beverage, such as a soda, for example root beer, cola, or another flavor, with ice cream. Currently, beverage floats are made by inserting ice cream into a beverage cup, and filling the cup with a beverage. A problem with this method is that, unless the beverage cup is very large, there is only a limited amount of beverage that can fit into the cup to accommodate room for both the beverage and the ice cream. Also, once the float is made according to this method, it is very difficult or even impossible to scoop out only ice cream separately from the beverage, or to drink only the beverage separately from the ice cream.

To alleviate some of these problems, attachments to beverage cups have been developed that are typically removably attached to a beverage cup or bottle that stores a beverage. Although some of these attachments have the ability to store a food, such as ice cream, separately from the beverage, typically the known attachments only serve as a conduit between the cup or bottle and a user's mouth. Thus, when the user inverts the cup or bottle, the beverage flows from the cup or bottle and flows into the attachment and over the ice cream allowing the beverage to become mixed with the ice cream before entering the user's mouth. However, when the cup or bottle is returned to its upright position, any of the beverage remaining in the attachment flows back down into the cup or bottle.

As such, a need exists for an improved beverage container attachment, which attaches to a beverage container and allows a beverage to flow from the beverage container to the attachment, while preventing the beverage from re-entering the beverage container once it has exited therefrom.

### SUMMARY OF THE INVENTION

In one embodiment, the present invention is a beverage container attachment that includes a cup portion having an inner surface that forms a reservoir for receiving a food substance and a connector having an opening, wherein the connector is for attaching the cup portion to a beverage container. The beverage container attachment also includes a beverage regulator attached to a wall that defines the connector opening to allow a beverage to enter the reservoir through the connector opening while preventing the beverage from exiting through the connector opening.

In another embodiment, the present invention is a beverage container attachment that includes a cup portion having an inner surface that forms a reservoir for receiving a food substance and a connector having an opening, wherein the connector is for attaching the cup portion to a beverage container. The beverage container attachment also includes a conduit disposed within the reservoir and attached to a wall that defines the connector opening to allow a beverage to enter the reservoir through the connector opening while preventing a beverage from exiting through the connector opening. The conduit includes a lower end with an opening that is in fluid communication with the connector opening to receive the beverage from the beverage container. The lower end of the conduit forms a fluid tight seal with the wall that defines the connector opening.

In yet another embodiment, the present invention is a beverage assembly that includes a beverage container having a beverage disposed therein and having an opening through which the beverage may pass. The beverage assembly also includes a beverage container attachment that includes a cup portion having an inner surface that forms a reservoir for receiving a food substance and a connector having an opening in fluid communication with the beverage container opening. The connector removably attaches the cup portion to the beverage container. The beverage container attachment also includes a conduit disposed within the reservoir and including a lower end having an opening and an upper end having an opening. The lower end of the conduit forms a fluid tight seal with the wall that defines the connector opening. The lower end opening of the conduit is in fluid communication with the connector opening and the beverage container opening to allow the beverage from the beverage container to enter the connector opening, traverse the lower end opening of the conduit, and exit the conduit through the upper end opening of the conduit to enter the reservoir, while the fluid tight seal prevents the beverage from exiting the reservoir through the connector opening.

### BRIEF DESCRIPTION OF THE DRAWINGS

FIG. 1 is a perspective view of one embodiment of a beverage container attachment according to the invention;

FIG. 2 is a perspective view of another embodiment of a beverage container attachment according to the invention;

FIG. 3A is a cross-sectional view of a cup portion of the beverage container attachment of FIG. 1;

FIGS. 3B is a cross-sectional view of another embodiment of a cup portion of a beverage container according to the invention;

FIGS. 3C is a cross-sectional view of still another embodiment of a cup portion of a beverage container according to the invention;

FIGS. 3D is a cross-sectional view of yet another embodiment of a cup portion of a beverage container according to the invention;

FIG. 4A is a cross-sectional view of a lid portion of the beverage container attachment of FIG. 1;

FIG. 4B is a cross-sectional view of a lid portion of the beverage container attachment of FIG. 2; and

FIG. 5 is a perspective view of a beverage container and a beverage container attachment according to another embodiment of the invention; and

FIG. 6 is a cross-sectional view of a beverage container and another embodiment of a beverage container attachment according to the invention.

### DETAILED DESCRIPTION OF THE DRAWINGS

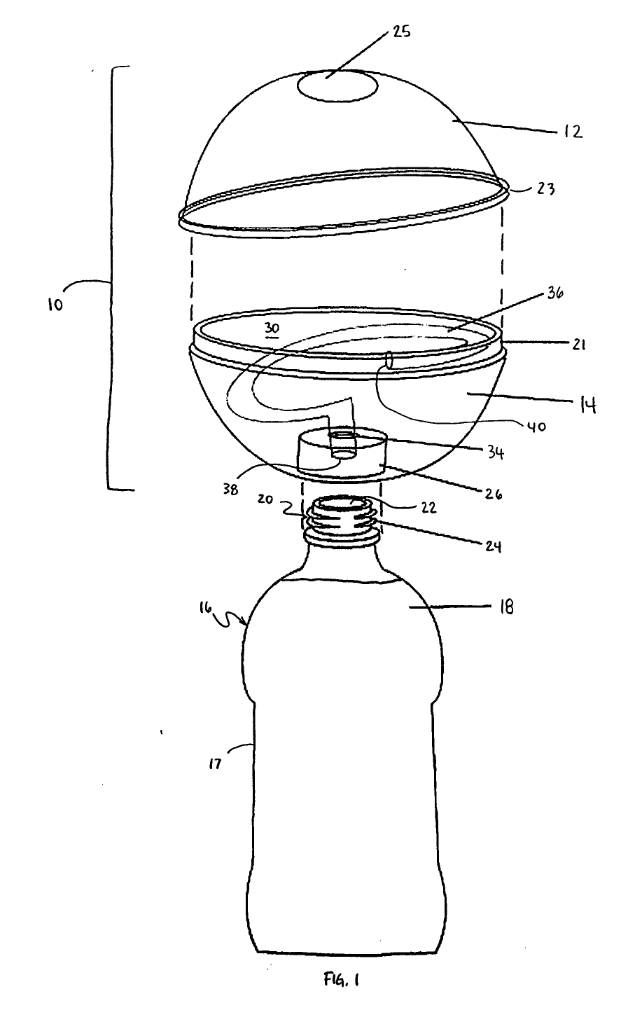

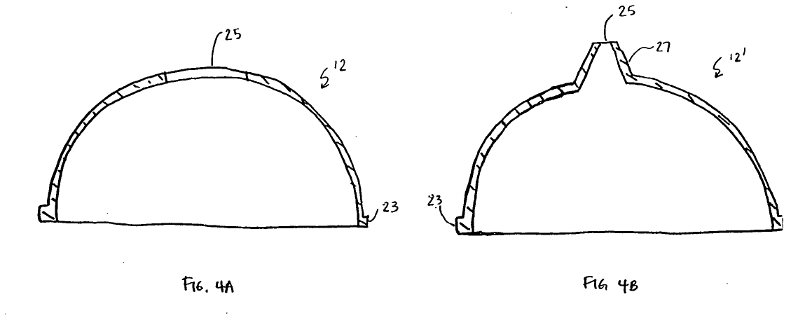

As shown in FIGS. 1-6, embodiments of the present invention are directed to a beverage container attachment that forms a removable connection with a container that stores a beverage (hereinafter “beverage container.”) The beverage container attachment includes a cup portion having an inner surface that forms a reservoir for receiving a food substance, such as ice cream. The cup portion also includes a lower portion having an opening with a structure attached thereto for allowing the beverage from the beverage container to enter through the cup portion opening while preventing the beverage from exiting through the cup portion opening. Thus, when the beverage from the beverage container enters the cup portion opening, the beverage and the food substance combine to form a mixture, such as a beverage float, that is contained within the reservoir of the cup portion of the beverage container attachment. As used herein terms such as “upper”, “lower”, “top” and “bottom” are relative terms and do not necessarily denote the actual position of an element.

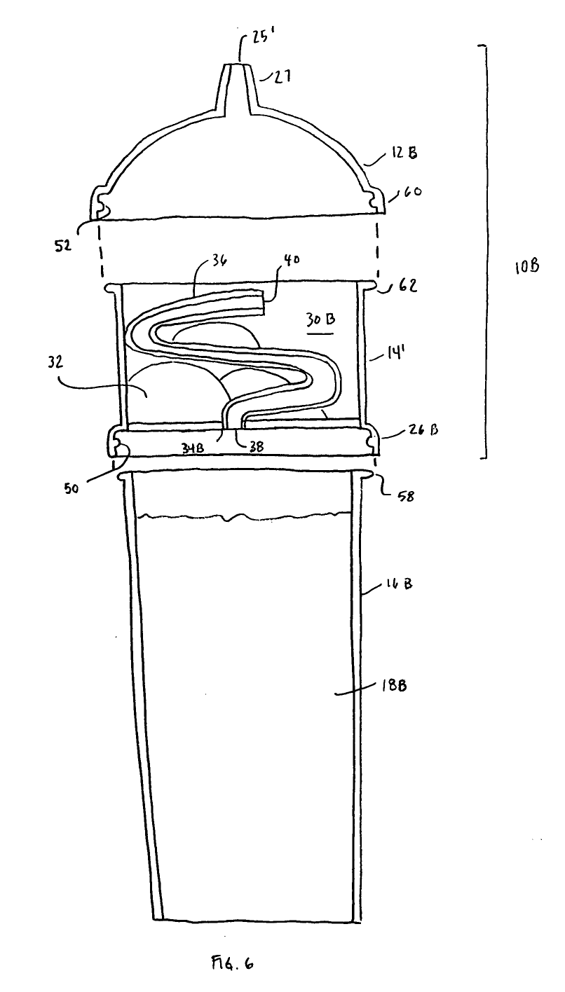

FIG. 1 shows a beverage container attachment 10 according to one embodiment of the present invention. The beverage container attachment 10 is for connection to a beverage container 16, which stores a beverage 18. In the embodiment depicted in FIG. 1, the beverage container 16 is a standard re-sealable plastic beverage bottle, which is common throughout the beverage industry, such as those commonly produced by the Coca Cola Company® and PepsiCo®. However, in other embodiments, the beverage container 16 may be any other suitable container for storing a beverage, such as a typical fountain drink cup as shown in FIG. 6, or a typcial drink “can.”

The beverage container 16 may be manufactured to any one of a variety of sizes. For example, standard sizes in the beverage industry include beverage containers 16 adapted to receive a beverage volume of 20 fluid ounces, 500 milliliters, 1 liter and 2 liters, respectively.

As shown in FIG. 1, the beverage container 16 includes a neck 20 that has an opening 22 through which the beverage 18 may pass and external threads 24 for connection to an internally threaded re-sealable cap (not shown). Typically, the neck 20 of the beverage container 16 is manufactured to a standard size and a standard shape regardless of the beverage volume for which the beverage container 16 is adapted to receive. For example, the opening 22 of the neck 20 is formed to a standard diameter and the external threads 24 of the neck 20 are formed to a standard pitch and a standard diameter that are common throughout the beverage industry regardless of the beverage volume for which the beverage container 16 is adapted to receive.

As is also shown in FIG. 1, the beverage container attachment 10 includes a lid portion 12 and a cup portion 14. In one embodiment, the lid and cup portions 12 and 14 are each formed from a molded plastic material, such as through an injection molding process. For aesthetic appeal (as discussed in more detail below), the lid and cup portions 12 and 14 may each be formed from a clear plastic material so that the contents within the lid and cup portions 12 and 14 may be seen externally therefrom, even when the lid and cup portions 12 and 14 are connected.

In the depicted embodiment, the lid and cup portions 12 and 14 each form a semi-spherical shape. However, in other embodiments the lid and cup portions 12 and 14 may have other shapes such as elliptical, rectangular, or square, among other appropriate shapes and/or configurations. In addition, although the lid and cup portions 12 and 14 are shown as having substantially the same size and shape, in other embodiments the lid and cup portions 12 and 14 may be formed of a dissimilar size and/or a dissimilar shape.

In one embodiment, the lid and cup portions 12 and 14 form a removable fluid tight connection. For example, in the depicted embodiment the cup portion 14 includes a rim 21 that receives a lower end of the lid portion 12. In such an embodiment, the outer perimeter of the rim 21 of the cup portion 14 is at least slightly larger than the inner perimeter of the lower end of the lid portion 12 to form a tight connection therebetween.

Alternatively or in addition, the rim 21 of the cup portion 14 and the lower end of the lid portion 12 may each contain threads for forming a threaded connection therebetween. The lower end of the lid portion 12 may also include a reinforcement 23 around its outer perimeter for structural stability in the area of attachment to the rim 21 of the cup portion 14. In another embodiment, the rim 21 of the cup portion 14 and the lower end of the lid portion 12 may alternatively or additionally form a snap fit or interlocking connection.

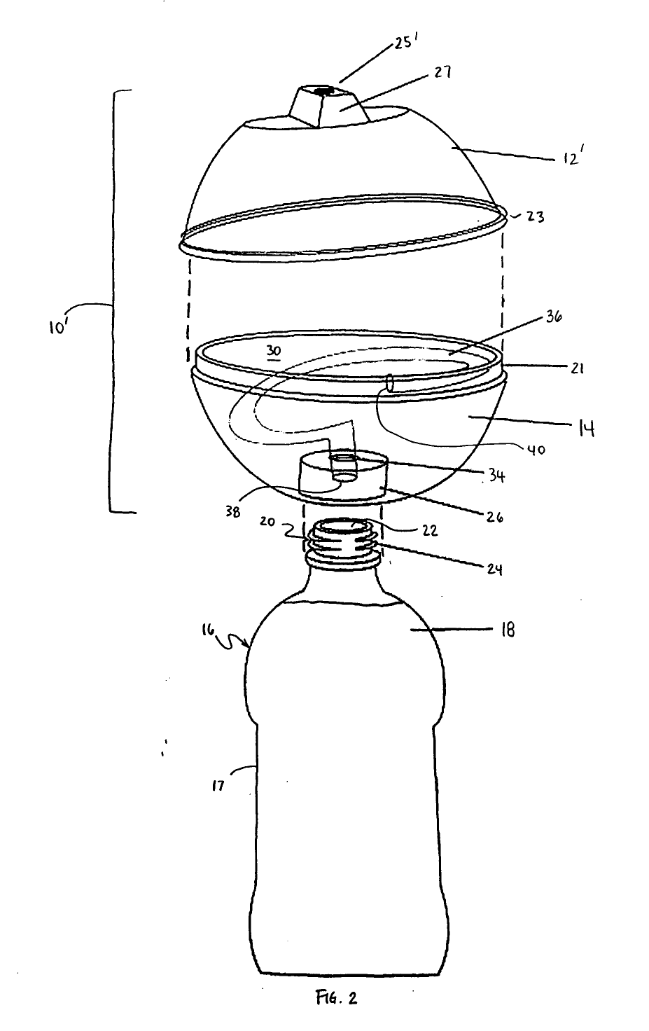

The lid portion 12 also includes a drink opening 25. In the embodiment of FIG. 1, the drink opening 25 is formed as a cut-out in the outer perimeter of the lid portion 12. In the embodiment of FIG. 2, the drink opening 25′ is formed in an ergonomically shaped spout 27 that is attached to the outer perimeter of the lid portion 12′. The spout 27 is formed to be easily grasped by the lips of a user. The spout 27 may be formed in a molding process integral with the remainder of the lid portion 12′.

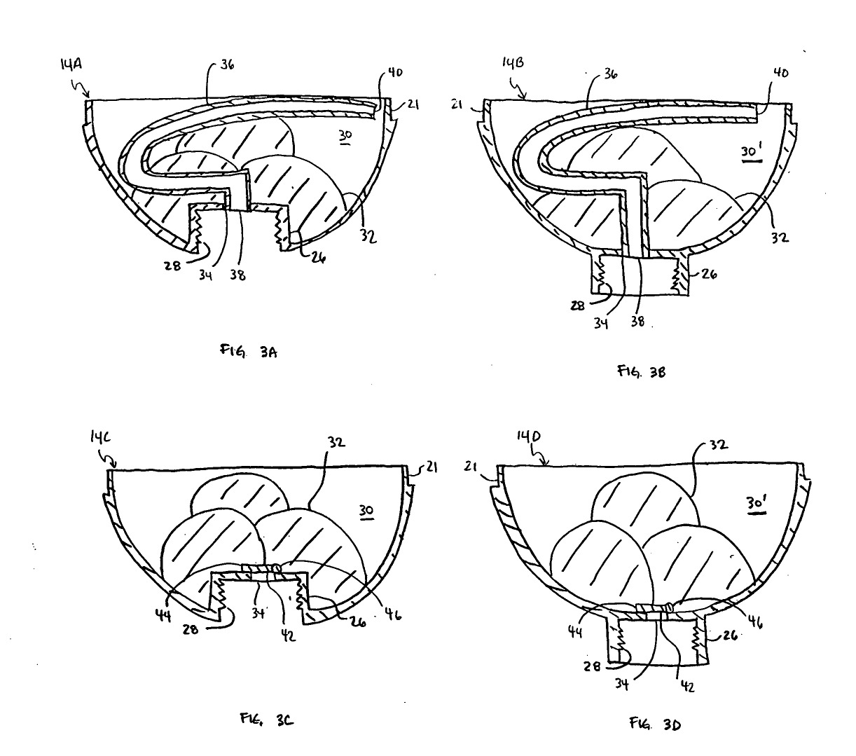

The cup portion 14 forms a reservoir 30 for receiving a food substance 32. It should be noted that the food substance 32 has been omitted from FIG. 1 for clarity purposes, but is shown in FIGS. 3A-3D. In one embodiment, the food substance 32 is a frozen food substance, such as ice cream, frozen yogurt, or ice among other appropriate frozen food substances. Although the food substance 32 may include any desired single food substance or any combination of food substances, in one embodiment the food substance 32 is any food substance that is desirable or flavorsome when mixed with a beverage, such as a soda beverage. Exemplary food substances 32 include candy, gum, spices, flavored powders, or flavored syrups, among other appropriate food substances.

Similarly, the beverage container 16 may include any desired beverage 18, such as a soda, a cola, a fruit juice, or a flavored water, among other appropriate beverages. Although the beverage container 16 may include any desired beverage 18, in one embodiment the beverage 18 is any beverage 18 that is desirable or flavorsome when mixed with a frozen food substance, such as ice cream or frozen yogurt.

The cup portion 14 also includes a connector 26 that connects the beverage container attachment 10 to the beverage container 16. In an exemplary embodiment, the connector 26 removably engages the neck 20 of the beverage container 16 and forms a fluid tight seal when it is connected therewith. FIGS. 3A-3D show exemplary embodiments of the cup portion 14 for use in the beverage container attachment 10 according to the present invention.

The connector 26 may be integrally formed with the cup portion 14 or the connector 26 may be a separate component that is mounted to the cup portion 14. In the embodiments of FIGS. 3A-3D, the connector 26 includes internal threads 28 that threadably engage the external threads 24 of the neck 20 of the beverage container 16. In such embodiments, the pitch and diameter of the threads 28 of the connector 26 conform to the standard pitch and the standard diameter of a standard cap, which is common throughout the beverage industry. However, the present invention contemplates changes to the standard neck, size, shape and externally threads. As such, the connector 26 threads may have any suitable shape, size and threads.

The connector 26 and the connector threads 28 may be formed in a molding process integral with the remainder of the cup portion 14. In another embodiment, the connector 26 is the standard cap, which is common throughout the beverage industry. In such an embodiment, the standard cap may be attached to the cup portion 14 by an adhesive, an epoxy, a heat fusion process or any other appropriate method of attachment.

In the embodiments of FIGS. 3A and 3C, the connector 26 is recessed into the generally semi-circular shape of the outer surface of the cup portion 14A and 14C. In the embodiments of FIGS. 3B and 3D, the connector 26 protrudes from the generally semi-circular shape of the outer surface of the cup portion 14B and 14D forming a larger resevoir 30′ than the reservior 30 of FIGS. 3A and 3C (hereinafter, unless specifically stated otherwise, the cup portion 14 is used to refer to any of the cup portion embodiments 14A-14D described above.)

Although the connector 26 has been described as having internal threads 28 that threadably engage the external threads of the neck 20 of the beverage container 16, other suitable methods and devices for forming a fluid tight seal between the cup portion 14 and the beverage container 16 are also contemplated by the present invention.

The connector 26 also includes an opening 34. In the embodiments of FIGS. 3A-3B, a conduit 36, having a lower opening 38 and an upper opening 40, is attached to a wall that defines the connector opening 34. In one embodiment, the conduit 36 forms a fluid tight seal with the wall that defines the connector opening 34, for example, by inserting a lower end of the conduit 36 into the connector opening 34, such that the lower opening 38 of the conduit 36 is adjacent to the wall that defines the connector opening 34, and affixing the lower end of the conduit 36 to the wall that defines the connector opening 34, such as by applying an adhesive, an epoxy, or by use of a heat fusion process or any other appropriate method of attachment.

Alternatively, a small spout (not shown) may extend from the wall that defines the connector opening 34. In such an embodiment, the lower end of the conduit 36 is affixed directly to the spout and/or the wall that defines the connector opening 34. An advantage of this embodiment is that the spout can be made to any height to increase the contact area between the lower end of the conduit 36 and the spout for increased stability. The spout may be formed in a molding process integral with the remainder of the cup portion 14.

In one embodiment, the conduit 36 spirals upwardly within the reservoir 30 or 30′ of the cup portion 14 or 14″, with the upper opening 40 of the conduit 36 disposed at a substantially horizontal orientation and terminating at and/or mounted to an upper end of the cup portion 14 or 14″, such as at a location adjacent to the rim 21. In one embodiment, the conduit 36 is formed from a clear plastic material, such as a typical drinking straw.

In the embodiments of FIGS. 3A and 3C, a one-way valve 42 is attached to the connector opening 34. In the depicted embodiments, the one-way valve 42 includes a cover plate 44 that is larger than and overlaps the connector opening 34. The one-way valve 42 also includes a hinge 46 connected to the cover plate 44 adjacent to the connector opening 34. In one embodiment, the cover plate 44 is formed of a plastic material and the hinge 46 is an integrally formed film hinge. The cover plate 44 and hinge 46 may be formed in a molding process integral with the remainder of the cup portion 14.

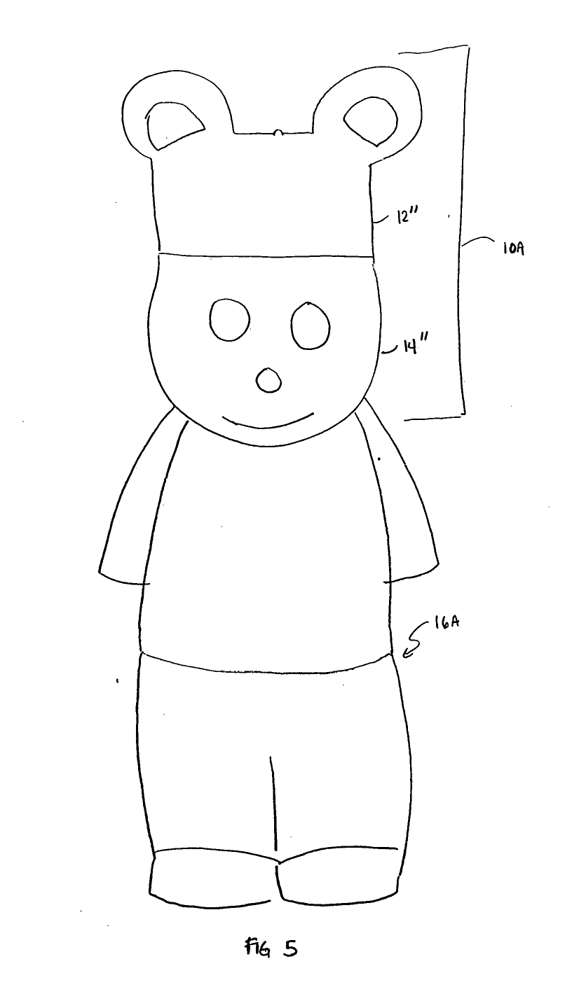

As shown in FIG. 5, in one embodiment the beverage container attachment 10A and the beverage container 16A combine to give the appearance of a character, such as a fictional character, a cartoon, an animal or a famous person, as well as other possible objects and/or decorative configurations. For example, in the embodiment depicted in FIG. 5, the beverage container 16A is formed as the body of a character, the cup portion 14″ is formed as the head of a character and the lid portion 12″ is formed as a hat that attaches to the head of the character.

As shown in FIG. 6, in one embodiment the beverage container attachment 10B is for attachment to a typical stackable fountain drink cup 16B. In such an embodiment, the connector 26B is integrally formed the remainder of the cup portion 14′ and protrudes from a lower portion of the cup portion 14′. The conduit 36 or the one-way valve 42 is attached to, within or adjacent to the connector opening 34B by any of the methods described above such that the beverage 18B from the beverage container 16B may enter the reservoir 30B of the cup portion 14′ to mix with the food substance 32 contained therein as described above.

In the embodiment of FIG. 6, the connector 26B of the cup portion 14′ includes a detent 50 for forming a removable connection with an upper flange 58 of the beverage container 16B. Similarly, the lid portion 12B includes a lower lip 60 having a detent 52 for removeably attaching to an upper flange 62 of cup portion 14′. In addition, in one embodiment, the lower lip 60 of the lid portion 12B may also be removably attached to the beverage container 16B by connecting the detent 52 of the lip portion 12B to the upper flange 58 of the beverage container 16B. Alternatively, the connector 26B of the cup portion 14′ may have any appropriate structure for attaching to the beverage container 16B and the lid portion 12B may have any appropriate structure for attaching to the cup portion 14′ and/or for attaching to the beverage container 16B.

In any of the embodiments described above, when the cup portion 14 is attached to the beverage container, the conduit 36 (in embodiments where the conduit 36 is included) or the one-way valve 42 (in embodiments where the one-way valve 42 is included) allows the beverage 18 from the beverage container 16 to enter through the connector opening 34, while preventing the beverage 18 from exiting the reservoir 30 through the connector opening 34.

The beverage container attachment of any of the embodiments described above can be used to create a mixture of a food substance and a beverage such as to form a beverage float. For example, one method of creating such a mixture includes connecting the beverage container attachment to the beverage container 16 and filling the beverage container attachment 10 with a desired food substance 32, such as ice cream. The beverage container 16 is then compressed, such as by compressing or squeezing a sidewall portion 17 of the beverage container 16. Squeezing the beverage container 16 causes portions of the beverage 18 from the beverage container 16 to exit the beverage container 16 through the neck opening 22 and enter the cup portion 14 of the beverage container attachment 10 through the connector opening 34.

In embodiments where the cup portion 14 includes the conduit 36, the beverage 18 continues to flow from the connector opening 34 into and through the lower opening 38 of the conduit 36, and exits the conduit 36 through the upper opening 40 of the conduit 36. The beverage 18 then enters the reservoir 30 of the cup portion 14 and mixes with the food substance 32 therein. Since the lower end of the conduit 36 covers the connector opening 34 and forms a fluid tight seal therewith, the beverage 18 that enters the reservoir 30 is not allowed to exit the reservoir 30 through the connector opening 34.

In embodiments where the cup portion 14 and the conduit 36 are each formed from a clear material, an entertaining visual is produced when the beverage 18 traverses the conduit 36. The entertainment of this visual is enhanced when the conduit 36 spirals upwardly within the reservoir 30 of the cup portion 14. This visual is enhanced even further when the food substance 32 is ice cream and the beverage 18 is a carbonated soda beverage due to the “explosion” that is created each time the carbonated soda beverage initially mixes with any exposed surface of the ice cream.

The substantially horizontal orientation of the upper opening 40 of the conduit 36 allows the beverage 18 that is transferred from the beverage container 16 to the beverage container attachment 10 to enter the reservoir 30 at a horizontal orientation, reducing the likelihood that the beverage 18 will “shoot out” directly from the beverage container 16 and exit the drink opening 25, as can occur when the beverage 18 that is transferred from the beverage container 16 to the beverage container attachment 10 enters the reservoir 30 at a vertical orientation.

In embodiments where the cup portion 14 includes the one-way valve 42, compressing the beverage container 16, such as by a squeezing of the sidewall 17 of the beverage container 16, causes a the beverage 18 from the beverage container 16 to apply an upward force on the lid plate 44, which in turn causes the lid plate 44 to rotate about the hinge 46, allowing the beverage 18 to enter through the cup portion 14 through the connector opening 34 and mix with the food substance 32 within the reservoir 30. When the beverage container 16 is released, the beverage 18 from the beverage container 16 no longer applies a force on the lid plate 44 and the lid plate 44 is allowed to rotate downwardly, aided by the force of gravity and the force of the beverage 18 that has entered the reservoir 30. As such, when the beverage container 16 is released, the lid plate 44 re-covers the connector opening 34 and the beverage 18 that is contained within the reservoir 30 is prevented from exiting the reservoir 30 through the connector opening 34.

In embodiments including the conduit 36, as well as in embodiments including the one-way valve 42, the user can regulate the amount of beverage 18 that enters the reservoir 30 of the cup portion 14 by continuing to compress or squeeze the sidewall 17 of the beverage container 16 until a desired amount of the beverage 18 has been transferred from the beverage container 16 to the reservoir 30. The user can then consume the beverage 18/food substance 32 mixture by inserting a straw or spoon through the drink opening 25 of the lid, or by inverting the beverage container attachment 10 and drinking directly from the drink opening 25. The fluid tight seal between the lid and cup portions 12 and 14 prevents leakage through the connection of the lid and cup portions 12 and 14 when the beverage container attachment 10 is thus inverted.

The user can also consume the mixture of the food substance 32 and the beverage 18 by removing the lid portion 12 from the cup portion 14 and inserting a straw or spoon directly into the cup portion 14 or by drinking from the rim portion 21 of the cup portion 14. At any time before or after the beverage 18/food substance 32 mixture has been created, any desired amount of the beverage 18 that remains in the beverage container 16 can be transfer to the reservoir 30.

In addition, at any time before or after the beverage 18/food substance 32 mixture has been created, the beverage container attachment 10 may be removed from the beverage container 16 and manipulated as an independent bowl or an independent cup to consume the beverage 18/food substance 32 mixture that is contained within the reservoir 30. Removing the beverage container attachment 10 from the beverage container 16 allows the user to consume the beverage 18 from the beverage container 16, separate from the food substance 32, even after a portion of the beverage 18 from the beverage container 16 has been used to create the beverage 18/food substance 32 mixture in the reservoir 30 of the beverage container attachment 10.

In addition, the beverage container attachment 10 can be removed before any of the beverage 18 has been transfer from the beverage container 16 to the beverage container attachment 10 so that the food substance 32 can be consumed separately from the beverage 18. In one embodiment, a bottom surface of the cup portion 14 is substantially flat or co-planar to facilitate placing the cup portion 14 on a flat surface when the cup portion 14 is removed from the beverage container 16.

It is contemplated that the beverage container attachment 10 may be sold together with the beverage container 16 or sold independently from the beverage container 16. In either event, the beverage container attachment 10 may be repeatedly reused with different beverage containers 16, such as when the beverage containers 16 becomes empties of its beverage 18. In this way, the same beverage container attachment 10 can be used with different beverage containers 16 containing any desired beverage 18 to create any desired mixture.

The preceding description has been presented with reference to various embodiments of the invention. Persons skilled in the art and technology to which this invention pertains will appreciate that alterations and changes in the described structures and methods of operation can be practiced without meaningfully departing from the principle, spirit and scope of this invention.

What is claimed is:

1. A beverage container attachment comprising:
a cup portion comprising an inner surface that forms a reservoir for receiving a food substance and a connector having an opening, wherein the connector is for attaching the cup portion to a beverage container; and
a beverage regulator attached to a wall that defines the connector opening to allow a beverage to enter the reservoir through the connector opening while preventing the beverage from exiting through the connector opening.

2. The beverage container attachment of claim 1, wherein the beverage regulator is a conduit.

3. The beverage container attachment of claim 1, wherein the beverage regulator is a conduit that is completely contained within the reservoir.

4. The beverage container attachment of claim 1, wherein the beverage regulator is a conduit that spirals upwardly within the reservoir.

5. The beverage container attachment of claim 1, wherein the beverage regulator is a conduit having a lower end with an opening that is in fluid communication with the connector opening to receive the beverage from the beverage container and wherein the lower end of the conduit forms a fluid tight seal with the wall that defines the connector opening.

6. The beverage container attachment of claim 5, wherein the conduit comprises an upper end having an opening for dispensing beverage from the beverage container into the reservoir of the cup portion, and wherein the upper end opening is disposed at a substantially horizontal orientation and terminates at an upper end of the cup portion.

7. The beverage container attachment of claim 1, wherein the conduit comprises an upper end having an opening for dispensing beverage from the beverage container into the reservoir of the cup portion, and wherein the upper end opening is disposed at a substantially horizontal orientation and terminates at an upper end of the cup portion.

8. The beverage container attachment of claim 1, wherein the food substance is a frozen food substance.

9. The beverage container attachment of claim 8, wherein the food substance is a frozen food substance chosen from the group consisting of ice cream and frozen yogurt.

10. The beverage container attachment of claim 1, wherein the connector contains threads for forming a removable threaded connection with the beverage container.

11. The beverage container attachment of claim 1, further comprising a lid portion removably attached to the cup portion.

12. The beverage container attachment of claim 11, wherein the lid portion comprises a drinking opening.

13. The beverage container attachment of claim 11, wherein the lid portion comprises a spout having a drinking opening.

14. A beverage container attachment comprising:
a cup portion comprising an inner surface that forms a reservoir for receiving a food substance and a connector having an opening, wherein the connector is for attaching the cup portion to a beverage container; and
a conduit disposed within the reservoir and attached to a wall that defines the connector opening to allow a beverage to enter the reservoir through the connector opening while preventing a beverage from exiting through the connector opening, wherein the conduit comprises a lower end with an opening that is in fluid communication with the connector opening to receive the beverage from the beverage container and wherein the lower end of the conduit forms a fluid tight seal with the wall that defines the connector opening.

15. The beverage container attachment of claim 14, wherein the conduit comprises an upper end having an opening for dispensing beverage from the beverage container into the reservoir of the cup portion, and wherein the upper end opening is disposed at a substantially horizontal orientation and terminates at an upper end of the cup portion.

16. The beverage container attachment of claim 15, wherein the food substance is a frozen food substance chosen from the group consisting of ice cream and frozen yogurt.

17. The beverage container attachment of claim 14, wherein the connector contains threads for forming a removable threaded connection with the beverage container.

18. The beverage container attachment of claim 14, further comprising a lid portion removably attached to the cup portion.

19. The beverage container attachment of claim 14, wherein the lid portion comprises a drinking opening.

20. The beverage container attachment of claim 14, wherein the lid portion comprises a spout having a drinking opening.

21. A beverage assembly comprising:
a beverage container having a beverage disposed therein and having an opening through which the beverage may pass;
a beverage container attachment comprising:
a cup portion comprising an inner surface that forms a reservoir for receiving a food substance and a connector having an opening in fluid communication with the beverage container opening, wherein the connector removably attaches the cup portion to the beverage container; and
a conduit disposed within the reservoir and comprising a lower end having an opening and an upper end having an opening, wherein the lower end of the conduit forms a fluid tight seal with the wall that defines the connector opening, and wherein and the lower end opening of the conduit is in fluid communication with the connector opening and the beverage container opening to allow the beverage from the beverage container to enter the connector opening, traverse the lower end opening of the conduit, and exit the conduit through the upper end opening of the conduit to enter the reservoir, while the fluid tight seal prevents the beverage from exiting the reservoir through the connector opening.

22. The beverage assembly of claim 21, wherein the upper end opening of the conduit is disposed at a substantially horizontal orientation and terminates at an upper end of the cup portion

23. The beverage assembly of claim 21, wherein the food substance is a frozen food substance chosen from the group consisting of ice cream and frozen yogurt.

24. The beverage assembly of claim 23, wherein the beverage is a soda beverage.

25. The beverage assembly of claim 21, further comprising a lid portion removably attached to the cup portion.

26. The beverage assembly of claim 21, wherein the lid portion comprises a drinking opening.

27. The beverage assembly of claim 21, wherein the lid portion comprises a spout having a drinking opening.
